(19) United States
(12) Patent Application Publication
(10) Pub. No.: US 2001/0030807 A1
(43) Pub. Date: Oct. 18, 2001

(54) Polarization-independent type optical isolator

(75) Inventor: Masanori Ikari, Annaka-shi (JP)

Correspondence Address: OLIFF & BERRIDGE, PLC, 277 S. WASHINGTON STREET, SUITE 500, ALEXANDRIA, VA, 22314, US

(73) Assignee: Shin-Etsu Chemical Co., Ltd.

(21) Appl. No.: 09/802,843

(22) Filed: Mar. 12, 2001

(30) Foreign Application Priority Data
Mar. 15, 2000 (JP) 2000-071488

(51) Int. Cl. G02B 5/30; G02B 27/28

(52) U.S. Cl. 359/484; 359/496; 359/497

(57) ABSTRACT

The present polarization-independent type optical isolator has good optical characteristic and is produced easily in good yield.

A polarization-independent type optical isolator 10 comprising a first birefringent wedge plate 1 and a second birefringent wedge plate 2 of optically uniaxial birefringent single crystal sandwiched a faraday rotator 3, wherein an inclination surface 1a of the first birefringent wedge plate 1 faces to a light-incident side and an inclination surface 2a of the second birefringent wedge plate 2 faces to a light-output side, one of the inclination surfaces parallel to the other, and open area of pit pores on the surface of the optically uniaxial birefringent single crystal is at maximum 1% to the whole surface area thereof.

### BACKGROUND OF THE INVENTION

The present invention relates to a polarization-independent type optical isolator, which operates independently of a polarization plane of a signal light and which is employed an optical component in optical communication fields for transmitting a forward directed signal light but shutting out the reflected light thereof.

In case of long distance transmission during optical fiber communication, signal light rays reflect at end faces at many of optical components, such as lens, mirror filter or optical fiber and the reflected light rays cause light resonance in a light amplifier and thus bring about deterioration to the characteristics thereof. For this reason, an optical isolator is used to shut out the reflected light rays.

Since the polarization condition of the signal light transmitted through the optical fiber is unstable due to external stress and bending, it is preferred that the optical isolator used in the present invention is a polarization-independent type optical isolator which is independent of the polarization condition of the signal light.

Japanese Patent Application Publication No. 61-58809 discloses a polarization-independent type optical isolator provided with two birefringent wedge plates and a faraday rotator. Such polarization-independent type optical isolator has a high isolation character and is adequate for miniaturization.

To obtain even higher isolation characteristic or low polarization mode dispersion (PMD), for instance, Japanese patent No. 2,747,775 discloses a polarization-independent type optical isolator arranged optical isolation units in cascade of two stages.

An optically uniaxial birefringent single crystal is usually used for the birefringent wedge plate of these polarization-independent type optical isolator. However, the optical characteristics of the polarization-independent type optical isolator had varied depending on own characteristics used the single crystal. As a result of obtaining a large number of polarization-independent type optical isolator with poor optical characteristics, such as causing high insertion loss, diffusion or diffraction, poor yield of the optical isolator had been a problem.

### SUMMARY OF THE INVENTION

An object of the present invention solves the foregoing problem and provides a polarization-independent type optical isolator having excellent optical characteristics which is able to manufacture easily in a good yield.

The polarization-independent type optical isolator of the present invention developed in order to solve the forgoing problem has a first birefringent wedge plate and a second birefringent wedge plate of optically uniaxial birefringent single crystal sandwiched a faraday rotator, wherein an inclination surface of the first birefringent wedge plate faces to a light-incident side and an inclination surface of the second birefringent wedge plate faces to a light-output side, one of the inclination surfaces parallel to the other, and open area of pit pores on the surface of the optically uniaxial birefringent single crystal is at maximum 1% to the whole surface area thereof.

If the ratio exceeds 1%, the optical characteristics of the optical isolator would deteriorate due to the sudden increase in the insertion loss of the 1.55 μm band forward direction of light flow. Within the above range, the insertion loss of the optical isolator is excellent at approximately below 0.1 dB. Furthermore, it would not induce the transmission of the signal light of the optical isolator to diffuse or diffract. Accordingly, an yield of the optical isolators is good.

The optically uniaxial birefringent single crystal is obtained by a Czochralski method in which the single crystal is grown by immersing a single crystal seed into a liquid melted single crystal of raw material, then by rotating and pulling it up simultaneously. A pit pore is an opened pore that is not filled with crystal, which occurs in the direction of the growing crystal during its process of growing the single crystal.

The present optical isolator is small and can be easily produced by attaching the two birefringent wedge plates and faraday rotator together with an adhesive agent or a solder, then fixing it into a cylindric magnet.

It is preferred that the optically uniaxial birefringent single crystal is selected from Lithium niobate, Rutile, Calcite, yttrium vanadate and Lithium tantalate. The Lithium niobate is the most preferred.

Polarization-independent type optical isolator could be suitably implemented by inclining the crystal axis of the first birefringent wedge plate 22.5°, −22.5°, 67.5° or −67.5° from the wedge equal thickness line of the first birefringent wedge plate, and inclining the crystal axis of the second birefringent wedge plate 45° more from the first birefringent wedge plate toward the light rotation direction of the faraday rotator.

The multiple-stage polarization-independent type optical isolator of the present invention comprises even numbers of the forgoing polarization-independent type optical isolators, of which all of the polarization-independent type optical isolators are lined in order of the light-incident to output direction, and their crystal axis directions of each birefringent wedge plates faced together are inclined 90° with respect to the central axis of the optical direction.

### BRIEF EXPLANATION OF THE DRAWINGS

FIG. 1 is a partially cutout perspective view showing an embodiment of the polarization-independent type optical isolator according to the present invention.

FIG. 2 is a front view of the embodiment thereof.

FIG. 3 is a partially cutout perspective view showing an embodiment of the multiple-stage polarization-independent type optical isolator according to the present invention.

FIG. 4 is an analyzed front view of the embodiment thereof.

FIG. 5 is a graph showing the correlation between area ratio of the opened pore area of the pit pore to surface area of a optically uniaxial birefringent single crystal and the lowest to highest values of insertion loss of the polarization-independent type optical isolator.

FIG. 6 is a graph showing the correlation between area ratio of the opened pore area of the pit pore to surface area of a optically uniaxial birefringent single crystal and the lowest to highest values of insertion loss of the multiple-stage polarization-independent type optical isolator

### DETAILED EXPLANATION OF THE INVENTION

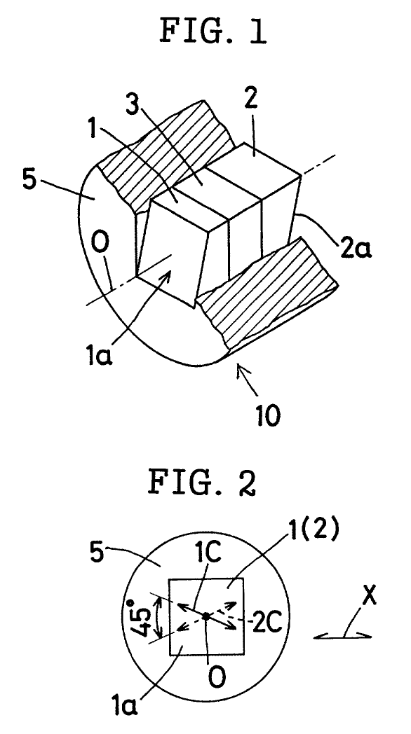

Embodiments of the polarization-independent type optical isolator according to the present invention will hereunder be described in more detail but claimed inventions are not limited by those embodiments. FIG. 1 is a partially cutout perspective view showing an embodiment of polarization-independent type optical isolator 10.

The polarization-independent type optical isolator 10 of the present invention is placed inside a cylinder shaped samarium cobalt magnet 5, in the order of a first birefringent wedge plate 1 of a lithium niobate (LiNbO₃) single crystal which is an optically uniaxial birefringent single crystal obtained by the Czochralski method, a faraday rotator 3 of rare earth element iron-garnet substituted bisumuth crystal, and a second birefringent wedge plate 2 of a lithium niobate single crystal.

As for the first birefringent wedge plate 1 and the second birefringent wedge plate 2, an optically uniaxial birefringent single crystal, which has a pit pore opening pore area ratio of 1% at maximum to the surface of the optically uniaxial birefringent single crystal, is used.

The optical direction O, i.e. the forward direction, for the present isolator 10 is in the direction of the first birefringent wedge plate 1, the faraday rotator 3, and the second birefringent wedge plate 2.

Each of the first birefringent wedge plate 1 and the second birefringent wedge plate 2 has a slant 1a and a slant 2a on either one of the light transmission surface. Slant 1a of the first birefringent wedge plate 1 is faced towards the light insertion side, and slant 2a of the second birefringent wedge plate 2 is faced towards the light output side.

Wedge equal thickness line of slant 1a and slant 2a are parallel to the upper and bottom sides. The other light transmission surface of each wedge plates 1 and 2 is not inclined and is faced towards the faraday rotator 3.

The crystal axis of the first birefringent wedge plate 1, i.e. optical axis 1C, is shifted 22.5° clockwise from the optical direction O side, against the wedge equal thickness line. The second birefringent wedge plate 2 is identical with the first birefringent wedge plate 1.

Since the first birefringent wedge plate 1 and the second birefringent wedge plate 2 in the present optical isolator 10 are lined inverting up and down and changing before and behind to each other, wedge equal thickness lines of slant 1a and slant 2a are both parallel to the wedge equal thickness line direction X shown in an arrow. In FIG. 2 observed from the optical direction O, the crystal axis 1C of the first birefringent wedge plate 1 is inclined 22.5° clockwise from the wedge equal thickness line direction X, and the crystal axis 2C of the second birefringent wedge plate 2 is inclined 22.5° counter-clockwise from the wedge equal thickness line direction X. Therefore, there is a shift of 45° between the crystal axis 1C and 2C.

Faraday rotation element 3 rotates the light 45° counterclockwise from the optical direction O side. Accordingly, the crystal axis 2C inclines 45° in the light rotation direction from the crystal axis 1C due to the rotation angle of the faraday rotator 3.

The operation of polarization-independent type optical isolator 10 is described below.

As the forward directed non-polarization light from a light source or an optical system enters the first birefringent wedge plate 1 for transmission purpose, incident light ray separates it into ordinary ray and extraordinary ray by the crystal axis 1C, then each polarization plane is rotated 45° in the proceeding left-handed screw direction by the faraday rotator 3. Since the crystal axis 2C of the second birefringent wedge plate 2 is inclined 45° in the proceeding left-handed screw direction from the crystal axis 1C, no shift in the polarization plane regarding ordinary and extraordinary light occurs against the crystal axis 2C, therefore, transmits them as ordinary and extraordinary lights. Since slant 1a and slant 2a are parallel, the ordinary light and the extraordinary light thereof become parallel light rays and coupled as non-polarization light as they are output from slant 2a, and proceeds toward the next transmission optical system.

When light flowing the opposite direction due to, for example, surface reflection of the next optical transition system enters the second birefringent wedge plate 2, it is separated into ordinary and extraordinary light by the crystal axis 2C, then is passed through the wedge board 2. Polarization plane of each ordinary and extraordinary light is rotated 45° by the faraday rotator 3. The rotation direction at this point is the same as the light forward direction but is in the right-handed screw direction since the progress is in the opposite direction.

Each polarization plane of ordinary and extraordinary lights are shifted 90° from the crystal axis 1C. For this reason, the ordinary light enters the first birefringent wedge plate 1 as extraordinary light, and the extraordinary light vice versa, as they spread their separation during the transmission process. The extraordinary and ordinary lights thereof go through further separation due to the effects of slant 1a. Accordingly, no light reflection will return to the light source or to the light source side of the optical system.

An experimental embodiment of the polarization-independent type optical isolator 10 thereof is described below.

Lithium niobate single crystal was used as a raw material of the optically uniaxial birefringent single crystal. The single crystal thereof was grown by heat melting a lithium niobate in a pot, then immersing a seed of lithium niobate single crystal in the liquid thereof, and slowly pulling up the seed while rotating it. After cutting more than seven of the single crystals thereof in round slices in the thickness of 60 to 80 mm, a mirror face polishing was performed on the cutting plane of the single crystal cut in round slices. Next, the single crystal was dealed with mono-polarizing treatment to arrange the polarization direction of niobium ion and lithium ion oriented randomly in the crystal and then etched process after twelve hours immersion in a 2% fluoride aqueous solution. The ratio of the opened pore area of the opened pit pore on the surface of the corresponding lithium niobate single crystal to the surface area of the lithium niobate single crystal thereof was calculated by taking a picture of the surface enlarged into 50 multiple by a microscope and measuring the opened pore area of the opened pit pore on the surface of the lithium niobate single crystal. Crystals cut in round slices having the ratio of less than 0.1% thereof were carefully distinguished.

A pair of wedge plates that had a length of 2.0 mm for all four sides and a maximum thickness of 0.5 mm was obtained by cutting out the present crystal so that the wedge equal thickness line direction X was shifted 22.5° from the direction of the crystal axis 1C and the inclination angle between the inclination surface and the non-inclination surface was 10°. An anti-reflection membrane to air was applied to the inclination surface and the non-inclination surface. The wedge plate with its inclination surface faced towards the light incident side was the first birefringent wedge plate 1 and the other wedge plate which was turned upside down and lined with its back turned was the second birefringent wedge plate 2.

Faraday rotation element 3 obtained by cutting out a 2.0 mm² of bismuth substitute rare earth iron garnet film having the thickness to obtain a 45° faraday rotation angle, which was applied an antireflection membrane to air, was sandwiched by both non-inclination surfaces of the first birefringent wedge plate 1 and the second birefringent wedge plate 2 and was fixed therebetween by a thermosetting silicone resin. This was inserted into a cylindrical magnet 5 and fixed therein by a thermosetting silicone resin to thus obtain a polarization-independent type optical isolator 10.

The polarization-independent type optical isolator was inserted between collimators which produce 360 μm parallel light, then an HP 8168F (Trade name code by Nippon Agilent Technologies Co. Litd.), which is a 1.55 μm band wavelength adjustable light source and Light Multi Meter HP 8153A (Trade name code by Nippon Agilent Technologies Co. Litd.), which is a detector, were used in order to measure the insertion loss of the forward direction of the 1.55 μm band. The insertion loss inside the inclination surface of the wedge plate was small, having the maximum value of 0.06 dB and the minimum value of 0.04 dB, and thus, the optical characteristic of the present polarization-independent type optical isolator was good.

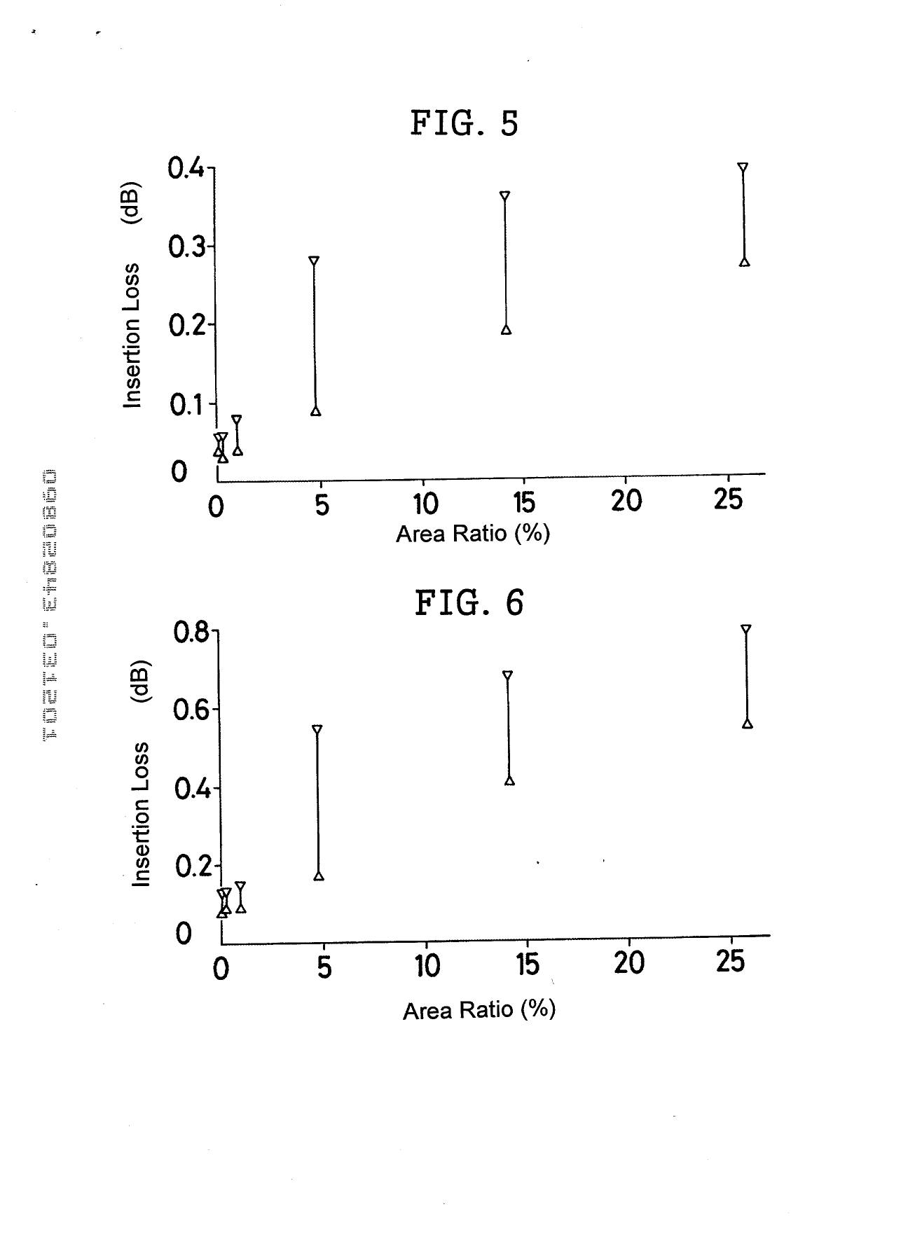

Samples of experimental polarization-independent type optical isolators were made in the same way as the above mentioned embodiment, except for the usage of crystals cut in round slices having the ratio of the opened pore area of the pit pore to the whole surface area of the single crystal less than 0.1%, 0.3%, 1.0%, 4.8%, 14.2%, and 25.9% were chosen to be used. The insertion loss of each sample was measured in the forward direction at a band of 1.55 μm. FIG. 5 shows the correlation of the ratio of the opened pore area of the pit pore to the single crystal surface area, and the maximum and the minimum value of the insertion loss inside the inclination surface of these optical isolators, by using V to show the maximum value and A to show the minimum. As is apparent from FIG. 5, if the area ratio is 1% or less, the insertion loss of the optical isolator is excellent at approximately 0.1 dB or less, and therefore, the yield of the optical isolator is good. If the ratio area exceeds 1%, the insertion loss suddenly increases and scatters, making an optical isolator that has poor optical characteristics, exceeding approximately 0.1 dB.

Furthermore, the resin used for attaching the wedge plate, the faraday rotator and the magnet explained in the example could be a metal attachment, such as a solder.

The following is the explanation of the embodiment of the multiple-stage polarization-independent type optical isolator applied to the present invention.

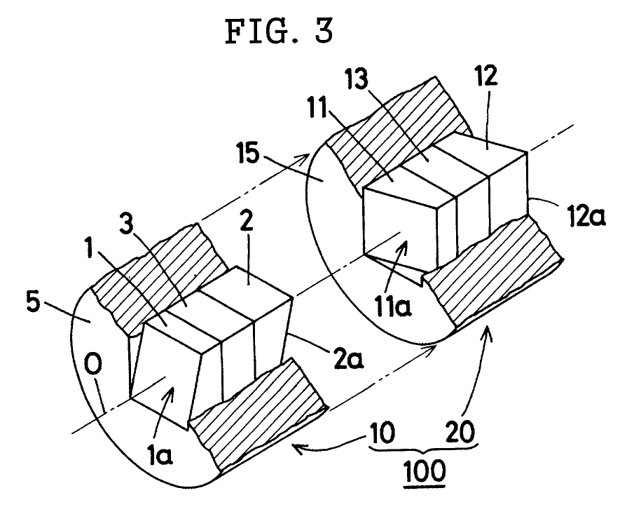

FIG. 3 is a partially cutout prospective view showing the embodiment of a multiple-stage polarization-independent type optical isolator 100. The multiple-stage polarization-independent type optical isolator 100 is a combination of optical isolator 10, which the composition thereof is identical with the optical isolator 10 shown in FIG. 1 and FIG. 2, and optical isolator 20, which the composition thereof is identical with the optical isolator 10 except that the directions of the crystal axis of their wedge plates differ from each other, are lined up in cascade in the direction of the optical insertion and output. The optical isolator 10 and 20 are arranged in the inclination of 90° from each other so that the wedge equal thickness line direction X of the wedge plates 1, 2 of the optical isolator 10 and the wedge equal thickness line direction Y of the wedge plates 11, 12 of the optical isolator 20 are arranged in an orthogonal position.

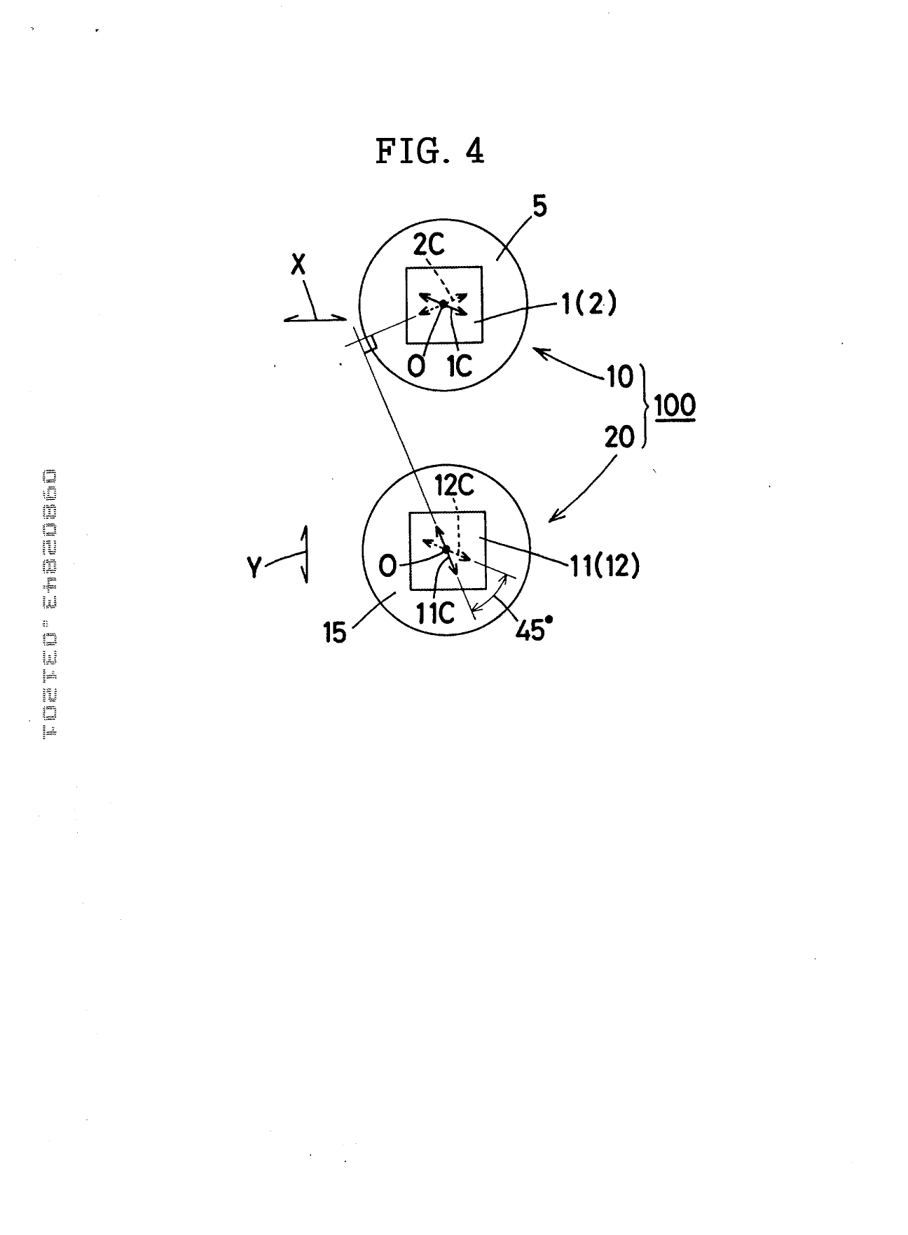

FIG. 4 shows a view of each of the optical isolator 10 and optical isolator 20 from the optical direction O by shifting each of the isolators parallel from one another in order to gain better understanding of the direction of the arrangement of optical isolator 10 and optical isolator 20.

Optical isolator 20 comprises a first birefringent wedge plate 11, which is completed by inclining the crystal axis 11C thereof 22.5° counter-clockwise from the wedge equal thickness line direction Y, and a second birefringent wedge plate 12 which is completed by inclining the crystal axis 12C thereof 67.5° counter-clockwise from the wedge equal thickness line direction Y.

Faraday rotation element 13 rotates the light 45° counterclockwise from the side of the optical direction O. Therefore, the crystal axis 12C is inclined 45° from the crystal axis 11C towards the optical rotation direction accordingly by the same rotation angle of the faraday rotator 13.

Wedge plate 2 of the optical isolator 10 and wedge plate 11 of the optical isolator 20 are faced towards each other. Crystal axis direction 2C of wedge plate 2 and crystal axis direction 11C of wedge plate 11 are positioned at a rotation angle of 90° apart from each other with respect to the central axis O of the optical direction.

Optical isolator 10 and optical isolator 20 are fixed by adhering magnet 5 and 15 together by a thermosetting silicone resin.

Multiple-stage polarization-independent type optical isolator 100 operates as follows.

Non-polarization light, which is incident upon the first birefringent wedge plate 1, undergoes slight time difference while being divided into ordinary light and extraordinary light by crystal axis 1C, then each plane of polarization is rotated 45° towards the proceeding left-handed screw direction by the faraday rotator 3.

The ordinary and extraordinary lights thereof transmit through the second birefringent wedge plate 2 without undergoing any changes, since no gaps in the plane of polarization occur against the crystal axis 2C, then are output from slant 2a as parallel lights, and are incident upon optical isolator 20 as non-polarization light. Since there is a 90° shift between the crystal axis 2C of the second birefringent wedge plate 2 of the optical isolator 10 and the crystal axis 11C of the first birefringent wedge plate 11 of the optical isolator 20, among the lights that are output from the second birefringent wedge plate 2, ordinary light enters the first birefringent wedge plate 11 as extraordinary light and extraordinary light as ordinary light.

The ordinary light and extraordinary light, which each of their polarization planes are rotated 45° towards the proceeding left-handed screw direction by the faraday rotator 13, transmit through the second birefringent wedge plate 12 as ordinary light and extraordinary light, without undergoing any changes.

For this reason, since the transmission time difference between the ordinary and extraordinary lights that occurs in the optical isolator 10 is canceled by the transmission time difference that occurs in the optical isolator 20, no polarization dispersion occurs. The ordinary light and the extraordinary light thereof are output from slant 12a as parallel lights, coupled, then proceeds on to the next transmission optical system as non-polarization light.

Reversed lights from the surface reflection of the next transmission optical system is transmitted by further increasing its separation as extraordinary light and ordinary light by the two optical isolators, and never returns to the light source or the light source side of the optical system.

By inserting a multiple-stage polarization-independent type optical isolator between the collimator, which produces 360 μm parallel light, the insertion loss of the forward direction was measured in a 1.55 μm band. Investigating the distribution of the insertion loss with respect to the inside of the inclination surface of the wedge plate, the maximum value was 0.12 dB and the minimum value was 0.08 dB, thus small, hence the optical characteristic of the multiple-stage polarization-independent type optical isolator was good.

FIG. 6 shows the correlation between the area ratio and the maximum value and the minimum value of the insertion loss of the forward direction at a 1.55 μm band of multiple-stage polarization-independent type optical isolator, which was experimentally made by using single crystals having its ratio of the opened pore area of the pit pore set to less than 0.1%, 0.3%, 1.0%, 4.8% 14.2% or 25.9% against the surface area of the single crystal. As is apparent from FIG. 6, optical isolators having an area ratio of 1% or less have an insertion loss of approximately 0.15 dB or less, which is excellent. Insertion loss increases radically when the area ratio exceeds 1%.

As explained above in detail, the polarization-independent type optical isolator of the present invention has low insertion loss of the signal light, has good optical characteristic, and is miniature. The present optical isolator never causes light diffusion or diffraction on the occasion of light transmission. The present isolator is produced easily with good yield.

What is claimed is:

1. A polarization-independent type optical isolator comprising a first birefringent wedge plate and a second birefringent wedge plate of optically uniaxial birefringent single crystal sandwiched a faraday rotator, wherein an inclination surface of the first birefringent wedge plate faces to a light-incident side and an inclination surface of the second birefringent wedge plate faces to a light-output side, one of the inclination surfaces parallel to the other, and open area of pit pores on the surface of the optically uniaxial birefringent single crystal is at maximum 1% to the whole surface area thereof.

2. The polarization-independent type optical isolator according to claim 1 characterized in that, said optically uniaxial birefringent single crystal is one selected from group consisting a Lithium niobate, Rutile, Calcite, yttrium vanadate and a Lithium tantalate.

3. The polarization-independent type optical isolator of according to claim 1 characterized in that, a crystal axis of said first birefringent wedge plate is inclined 22.5°, −22.5°, 67.5°, or −67.5° to the wedge equal thickness line thereof and a crystal axis of said second birefringent wedge plate is inclined 45° to the rotation direction from the crystal axis of the first birefringent wedge plate.

4. A multiple-stage polarization-independent type optical isolator comprising even numbers of polarization-independent type optical isolators described in claim 1, all of the polarization-independent type optical isolators are lined in order of the light-incident to output direction, and crystal axis directions of each birefringent wedge plates faced together are inclined 90° with respect to the central axis of the optical direction.

5. The multiple-stage polarization-independent type optical isolator of according to claim 4, wherein the even numbers of polarization-independent type optical isolators are characterized in claim 2.

6. The multiple-stage polarization-independent type optical isolator of according to claim 4, wherein the even numbers of polarization-independent type optical isolators are characterized in claim 3.
